(19) United States
(12) Patent Application Publication
(10) Pub. No.: US 2021/0001813 A1
(43) Pub. Date: Jan. 7, 2021

(54) Sensor Apparatus For Coupling To A Pane Of Glass

(71) Applicant: HELLA GmbH & Co. KGaA, Lippstadt (DE)

(72) Inventors: Eduard DESCH, Hude-Wusting (DE); Timo LANGE, Skye (DE); Franz HAAK, Bremen (DE)

(21) Appl. No.: 16/920,121

(22) Filed: Jul. 2, 2020

(30) Foreign Application Priority Data
Jul. 5, 2019 (DE) 10 2019 118 218.2

(51) Int. Cl. B60S 1/08

(52) U.S. Cl. CPC B60S 1/0833; B60S 1/0888; B60S 1/0881

(57) ABSTRACT

A sensor apparatus for coupling to a pane of glass, in particular to the windscreen of a motor vehicle, having at least one coupling layer for the optical coupling of the sensor apparatus with the windscreen. The coupling layer is constructed with multiple layers, at least two layers of the coupling layer consist of coupling materials that are different from each other, and the layer provided for placement on the pane of glass has a weaker capacity for adhesion to the glass than at least one further layer of the coupling layer.

### BACKGROUND OF THE INVENTION

### Field of the Invention

The invention relates to a sensor apparatus for coupling to a pane of glass, in particular to a windscreen of a motor vehicle, with at least one coupling layer for optical coupling of the sensor apparatus to the glass.

### Brief Description of the Related Art

Sensor apparatuses for coupling to a pane of glass are known and are used for example in the automotive field. Here, sensor apparatuses may be used for example to detect moisture, for example rain on a pane of glass, in particular on the windscreen. For this purpose, the sensor apparatus includes a radiation transmitter, for example a light emitting diode, for emitting radiation. The radiation is coupled into the windscreen and a least a fraction thereof is reflected totally inside the windscreen, wherein the size of the fraction of totally reflected radiation depends on the degree of wetness of the windscreen, and wherein the degree to which the windscreen is covered with moisture can be deduced from the fraction of the radiation which is coupled out. In order to enable the radiation to be coupled into the windscreen, coupling materials that support the optical coupling between the sensor apparatus and the windscreen may be used. Other sensor apparatuses, for example camera systems, light sensors and the other such apparatuses may also be coupled to a windscreen optically by means of coupling materials.

One drawback associated with the use of coupling materials is that they can adhere to the windscreen too strongly, thus making it impossible to remove the sensor safely and non-destructively.

### SUMMARY OF THE INVENTION

The object underlying the invention is to suggest a sensor apparatus of the type described in the introduction with which it becomes possible to detach the sensor apparatus from a windscreen non-destructively.

This object is solved with a sensor apparatus having the features of the independent claim(s). Further developments and advantageous variants are described in the subordinate claims.

In a sensor apparatus for coupling to a pane of glass, in particular the windscreen of a motor vehicle, with at least one coupling layer for optical coupling of the sensor apparatus to the pane, it is provided as essential to the invention that the coupling layer is constructed of multiple layers, that at least two layers of the coupling layer are made from coupling materials that differ from each other, and that the layer provided as the layer for placement on the pane of glass has a lower capacity for adhesion to the glass than at least one further layer of the coupling layer. For optical coupling of the sensor apparatus to the windscreen, for example for the most efficient coupling in possible of the radiation emitted by a rain sensor or for coupling a camera system to a windscreen, the sensor apparatus has a coupling layer made from one coupling material. The coupling layer is brought directly into contact with the glass pane, in particular with the inside of the windscreen of a motor vehicle. The coupling layer is constructed with multiple layers, in particular two layers, wherein the layers are made from different materials. In particular, the layers may be formed by gel-like materials. In this context, the layer, which is placed directly against the glass pane, that is to say in direct contact therewith, has lower powers of adhesion to the glass then the other layer of the coupling layer. The reduced adhesion of the layer against the glass, in particular against the windscreen, makes simple, non-destructive detachment of the sensor apparatus from the glass possible. Moreover, the layer assigned to the sensor apparatus exhibits very good adhesion to the sensor apparatus, thus ensuring a secure bond.

In a further development of the invention, the different coupling materials have good bonding properties with each other. The coupling materials of the different layers of the coupling layer have good bonding properties with each other with the result that a secure bond exists between the layers of the coupling layer. For example, the materials of the different layers may be chemically similar to each other, so that good bonding properties between them may be obtained. In particular, the layer of the coupling layer which faces the sensor apparatus may have good bonding properties with the sensor apparatus, and the layer facing the glass pane may have only weak adhesion capabilities with the glass pane. In this way, a secure bond is created between the sensor apparatus and the coupling layer, while easy and therefore non-destructive detachability of the sensor apparatus from the windscreen is assured.

In a further development of the invention, the layer facing the pane of glass is made from a material that contains silicone oil, and the layer facing the sensor apparatus is made from a material that does not contain silicone oil. The layer which is provided for laying directly against the glass consists of a coupling material which contains a silicone oil, in particular a free silicone oil. This results in a reduced adhesion to the glass, that is to say good anti-adhesive effect between the layer and the pane of glass. Thus, a sensor apparatus which has been brought into connection with the glass pane via the layer containing silicone oil may be detached from the glass non-destructively. The layer facing the sensor apparatus contains no silicone oil, in particular no free silicone oil, and therefore has a good adhesive effect with the sensor apparatus. Since the two layers of the coupling layer are chemically similar, they themselves form a very good bond with each other, with the result that the sensor apparatus is bonded to the layer that contains silicone oil via the layer that contains no silicone oil.

In a further development of the invention, the layer facing the glass pane and made from silicone oil containing material forms a silicone oil film on the surface facing the glass. The layer facing the glass pane is made from a material that contains silicone oil. The silicone oil may form a silicone oil film on the layer surface which is intended to be applied to the glass pane that is to be monitored. The silicone oil film creates an anti-adhesion effect between the coupling layer and the glass that is to be monitored. This enables the sensor apparatus to be detached from the glass non-destructively again after it has been attached thereto. The layer containing no silicone oil, which is arranged on the coupling region of the sensor apparatus, forms a strong bond with the sensor apparatus. Since the two layers of the coupling layer form a strong bond with each other because of their chemically very similar properties, a defined detachment of the sensor apparatus is enabled. If both layers were to form a silicone oil film, it would also be possible for the coupling layer to remain stuck to the glass upon detachment, which is not desirable.

In a further development of the invention, the sensor apparatus has a housing, the housing has a coupling region at least a portion of which is of flat design for arrangement on the glass pane, the coupling region has a rim for forming a recess, and at least one layer is accommodated in the recess. The sensor apparatus has a housing in which the electronic components of the sensor apparatus, such as the radiation transmitter and the radiation receiver of a rain sensor, for example, or also the optical elements of a camera system are arranged. The housing has a coupling region which is provided for laying on the pane of glass that is to be monitored. In particular, the coupling region has an area which is transparent for the radiation, through which the radiation is able to pass out of and/or into the housing. A coupling layer is arranged between the coupling region and the glass pane for better optical coupling. The coupling region may be circular, for example. The coupling region may have a protruding rim, so that a recess is formed between the rim and the coupling region. A layer, in particular the layer of the coupling layer that contains no silicone oil is accommodated in the recess, thereby ensuring good adhesion between the coupling layer and the coupling region of the housing here.

In a further development of the invention, the layer containing no silicone oil is accommodated in the recess that is formed up to a level flush with the upper edge of the rim of the coupling region. The recess formed between the coupling region of the housing and the protruding border of the coupling region is filled with the material containing no silicone oil up to a level flush with the upper edge of the border. The layer of the coupling layer that contains no silicone oil is thus embedded in the recess. Embedding the layer of the coupling layer has the effect of created a secure connection between the layer containing no silicone oil and the sensor housing.

In a further development of the invention, the layer that contains silicone oil has a larger diameter than the layer that contains no silicone oil. The layer that contains silicone oil, which is provided for laying on the pane of glass to be monitored, has a larger diameter than the layer without silicone oil which is assigned to the coupling surface of the sensor housing. The layer containing silicone oil thus extends laterally beyond the free layer which contains no silicone oil and also extends beyond the region of the housing that forms the recess. In this way, a good optical coupling of the sensor apparatus with the glass pane is guaranteed. It is further assured that the strongly adhesive layer containing no silicone oil does not come into contact with the glass, and accordingly that easy removal of the sensor apparatus from the glass is not hindered by the layer that contains no silicone oil.

In a further development of the invention, the recess and the rim are covered with the layer containing silicone oil. The recess and the rim that forms the recess, in particular the portion of the rim closest to a pane of glass that is to be monitored, are covered by the layer that contains silicone oil. In this way, the layer without silicone oil which is accommodated in the recess is prevented from coming into contact with the glass when the sensor apparatus is placed against a pane of glass, and consequently hindering the non-destructive removal of the sensor apparatus from the glass.

In a further development of the invention, the coupling layer is constructed with two layers, and the separation plane between the two layers is aligned parallel to the plane in which the radiation is coupled into the glass. In a preferred embodiment of the invention, the coupling layer is constructed with two layers, wherein the separation plane is arranged between the two layers, that is to say the contact plane between the two layers is aligned parallel with the coupling plane of the housing spanned by the coupling region. Thus, with the sensor apparatus in the assembled state in a windscreen, the separation plane is aligned substantially between the two layers and thus also parallel to the windscreen in this region.

In a further development of the invention, the coupling materials are silicone gels. The materials of the various layers of the coupling layer consist of silicone gels. On the one hand, the layer provided for laying on the glass consists of a silicone gel with free silicone oil, whereas the layer facing the housing consists of a silicone gel without free silicone oil. The use of silicone gels is advantageous, because they can be applied and worked easily. In particular, the recess that has been formed can easily be filled with silicone gel, and in a second step the first silicone gel layer and the rim can be coated with a second silicone gel layer.

In one embodiment of the invention, the sensor apparatus is a rain-light sensor with at least one radiation transmitter for transmitting radiation and with at least one radiation receiver for detecting radiation. With a rain-light sensor arranged on the inside of a motor vehicle windscreen, the degree to which the windscreen is covered with moisture may be determined by coupling radiation into the windscreen and detecting the radiation that is coupled out again. For this purpose, good optical coupling of the sensor apparatus via a coupling layer is essential.

A further aspect of the invention relates to a motor vehicle with at least one pane of glass, in particular a windscreen, and with at least one sensor apparatus according to the invention, wherein the sensor apparatus is arranged on the interior surface of a pane of glass.

### BRIEF DESCRIPTION OF THE DRAWINGS

In the following section, the invention will be explained in greater detail with reference to an exemplary embodiment represented in the drawing. In detail, the diagrammatic figures show:

FIG. 1: a top view of a sensor apparatus with a coupling material, and

FIG. 2: a side view in cross section of a sensor apparatus with a coupling layer mounted on a pane of glass.

### DETAILED DESCRIPTION OF THE PREFERRED EMBODIMENTS

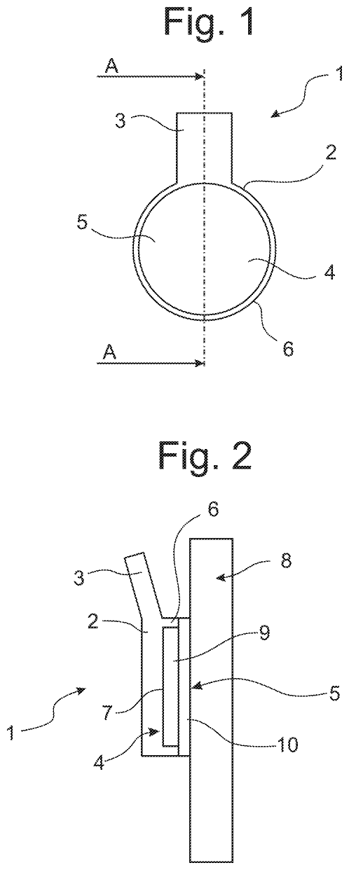

FIG. 1 represents a top view of the side of a sensor apparatus 1 that is assigned to a windscreen. The sensor apparatus 1 has a housing 2 with an interface 3, via which the sensor apparatus 1 may be connected to an evaluation unit for example in a manner that allows the flow of electricity and data. The housing 2 includes a coupling region 4 which is provided such that it may arranged to face the inside of a pane of glass, in particular a windscreen. The coupling region 4 includes a transparent region, through which radiation is able to pass into the interior of the housing 2 and pass out of said interior. In order to obtain the best possible optical coupling of the housing 2 with the pane of glass, a coupling layer 5 is arranged on the coupling region 4. The coupling region 4 has a rim 6, with which the coupling region 4 forms a recess 7. At least a portion of the coupling layer 5 is accommodated in the recess 7.

FIG. 2 represents a cross sectional side view of a sensor apparatus 1 according to FIG. 1. The coupling layer 5 is arranged between the coupling region 4 of the housing 2 and the glass pane 8 that is to be monitored. In this context, the coupling layer 5 is constructed with two layers. A first layer 9 is accommodated in the recess 7 of the coupling region 4 so as to reach a level flush with the top edge of the rim 6. The layer 9 accommodated in the recess 7 consists of a material that contains no silicone oil, in particular a silicone gel which contains no silicone oil. The layer 9 which contains no silicone oil and the rim 6 are covered with a layer 10 which contains silicone oil. In particular, layer 10 is made from a silicone gel which contains silicone oil. Since the layers 9 and 10 are made from chemically similar materials, the layers 9 and 10 form a strong connection with each other. The surface of the layer 10 which faces the glass pane 8 has a silicone oil film because of the silicone oil it contains, with the result that the layer 10 only has weak adhesion properties with the glass 8. This in turn enables non-destructive detachment of the sensor apparatus 1 from the glass 8. The layer 9, which is accommodated in the recess 7 of the housing 2, contains no silicone oil, so layer 9 exhibits strong adhesion to the housing 2. When the sensor apparatus 1 is removed from the glass 8, it is thus ensured that the layer 10 is detached from the glass 8, and the connection between the layer 9 and the housing 2 or between the layers 9 and 10 is not severed.

All of the features described in the preceding description and the claims can be combined in any permutation with all of the features of the independent claims. The disclosure of the invention is thus not limited to the feature combinations that are described and/or claimed, but rather all feature combinations which are practicable within the scope of the invention are to be considered disclosed.

1. Sensor apparatus for coupling to a pane of glass, in particular to the windscreen of a motor vehicle, with at least one coupling layer for optical coupling of the sensor apparatus to the glass,
wherein
the coupling layer is constructed of multiple layers,
at least two layers of the coupling layer are made from coupling materials that differ from each other, and
the layer provided as the layer for placement on the pane of glass has a lower capacity for adhesion to the glass than at least one further layer of the coupling layer.

2. The sensor apparatus according to claim 1, wherein different coupling materials have good bonding properties with each other.

3. The sensor apparatus according to claim 1, wherein at least one layer is made from a material that contains silicone oil, and at least one layer is made from a material that does not contain silicone oil.

4. The sensor apparatus according to claim 1, wherein the layer facing the pane of glass is made from a material that contains silicone oil, and the layer facing the sensor apparatus is made from a material that does not contain silicone oil.

5. The sensor apparatus according to claim 1, wherein the layer consisting of a material that contains silicone oil and facing the pane of glass forms a silicone oil film on the surface facing the glass.

6. The sensor apparatus according to claim 1, wherein the sensor apparatus has a housing, that the housing has a coupling region at least a portion of which is of flat design for arrangement on the pane of glass, that the coupling region has a rim for forming a recess, and that at least one layer is accommodated in the recess.

7. The sensor apparatus according to claim 6, wherein the layer containing no silicone oil is accommodated in the recess that is formed up to a level flush with the upper edge of the rim of the coupling region.

8. The sensor apparatus according to claim 1, wherein the layer that contains silicone oil has a larger diameter than the layer that contains no silicone oil.

9. The sensor apparatus according to claim 8, wherein the recess and the rim are covered with the layer that contains silicone oil.

10. The sensor apparatus according to claim 5, wherein the coupling layer is constructed with two layers, and the separation plane is arranged between the two layers parallel to the plane spanned by the coupling region.

11. The sensor apparatus according to claim 1, wherein the coupling materials are silicone gels.

12. The sensor apparatus according to claim 1, wherein the sensor apparatus is a rain-light sensor with at least one radiation transmitter for transmitting radiation and with at least one radiation receiver for detecting radiation.

13. A motor vehicle having at least one pane of glass, in particular a windscreen, and having at least one sensor apparatus according to claim 1, wherein the sensor apparatus is arranged on the inner surface of a pane of glass.
